(19) United States
(12) Patent Application Publication
(10) Pub. No.: US 2016/0208873 A1
(43) Pub. Date: Jul. 21, 2016

(54) Bicycle Lining Wear Indication System

(71) Applicant: CHIA CHERNE INDUSTRY CO., LTD., Changhwa City (TW)

(72) Inventors: Yung-Pin Kuo, Changhua City (TW); Kuan-Ying Lu, Changhua City (TW)

(21) Appl. No.: 14/600,038

(22) Filed: Jan. 20, 2015

(51) Int. Cl. F16D 66/02; B60T 17/22

(52) U.S. Cl. CPC F16D 66/021; B60T 17/22

(57) ABSTRACT

A bicycle lining wear indication system includes a lining and a display device. The lining includes a back pate, a friction portion and a detection device. The detection device includes a detecting unit, an operation unit and a transmitting unit. The detecting unit detects a wear state of the friction portion after the friction portion contacts and rubs the disk of a wheel to produce a friction coefficient characteristic. The operation unit proceeds an operation on the friction coefficient characteristic to convert the friction coefficient characteristic into a digital value. The transmitting unit transmits the digital value to the display device to remind a rider of a wear extent of the friction portion. Thus, the detection device monitors and detects the wear extent of the friction portion so that the rider can replace the lining when the friction portion is worn out.

### BACKGROUND OF THE INVENTION

1. Field of the Invention

The present invention relates to an indication system and, more particularly, to a lining wear indication system for a bicycle.

2. Description of the Related Art

A conventional disk brake device comprises a brake disk secured at one side of a hub of a bicycle (or a motorcycle) to move with a wheel of the bicycle synchronously, a brake caliper mounted on a frame of the bicycle and disposed adjacent to the brake disk, and a brake line mounted on the frame of the bicycle and connected with the brake caliper to drive the brake caliper. The brake caliper includes two linings between which the brake disk is disposed. When the brake caliper is driven by the brake line, the two linings are moved toward each other to clamp the brake disk to provide a braking effect to the wheel. However, the linings are easily torn or worn out during a long-term or frequent utilization so that when the rider does not replace the linings in time, the linings are inoperative or fail, thereby greatly decreasing the braking effect, and thereby causing danger to the rider.

### BRIEF SUMMARY OF THE INVENTION

In accordance with the present invention, there is provided a bicycle lining wear indication system comprising a lining and a display device. The lining includes a back pate, a friction portion combined with a surface of the back pate, and a detection device mounted on the back pate. The back pate has a positioning hole positioned on a brake caliper mechanism of a brake of a bicycle to attach the back pate to the brake. When in use, the back pate is driven by the brake caliper mechanism of the brake to drive the friction portion, so that the friction portion is moved to contact a disk of a wheel of the bicycle so as to provide a braking effect to the wheel. The detection device includes a detecting unit, an operation unit and a transmitting unit. The detecting unit is used for sensing and detecting a wear state of the friction portion of the lining after the friction portion contacts and rubs the disk of the wheel to produce a friction coefficient characteristic. The operation unit is coupled to the detecting unit to proceed an operation on the friction coefficient characteristic produced by the detecting unit and to convert the friction coefficient characteristic into a digital value. The transmitting unit is coupled to the operation unit to transmit the digital value produced by the operation unit to the display device to remind a rider of a wear extent of the friction portion. The display device is externally connected to the transmitting unit of the detection device.

Preferably, the transmitting unit includes a wireless transmission interface module connected to the display device to transmit the digital value produced by the operation unit to the display device.

Preferably, the wireless transmission interface module transmits the digital value produced by the operation unit to the display device by a wireless bluetooth transmission, a wireless emitting frequency transmission, a infrared wireless transmission or a wireless radio microwave transmission.

Preferably, the display device is an electronic product of a cell phone, a personal digital assistant or a tablet computer.

Preferably, the transmitting unit further includes a buzzing module to transmit an alarm sound to remind the rider of replacement of the friction portion of the lining.

Preferably, the buzzing module and the wireless transmission interface module of the transmitting unit are operated synchronously. Alternatively, the buzzing module and the wireless transmission interface module of the transmitting unit are operated individually.

According to the primary advantage of the present invention, the detection device monitors and detects the wear extent of the friction portion so that the rider can replace the lining when the friction portion is worn out, thereby assuring the rider's safety when riding the bicycle.

According to another advantage of the present invention, the buzzing module of the detection device transmits an alarm sound to remind the rider of replacement of the friction portion of the lining.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a lining of a bicycle lining wear indication system in accordance with the preferred embodiment of the present invention.

FIG. 2 is a schematic view showing usage of the lining of the bicycle lining wear indication system in accordance with the preferred embodiment of the present invention.

FIG. 3 is a locally enlarged view of the bicycle lining wear indication system as shown in FIG. 2.

FIG. 4 is a partially cross-sectional view of the bicycle lining wear indication system as shown in FIG. 2.

FIG. 5 is a block diagram of the bicycle lining wear indication system in accordance with the preferred embodiment of the present invention.

### DETAILED DESCRIPTION OF THE INVENTION

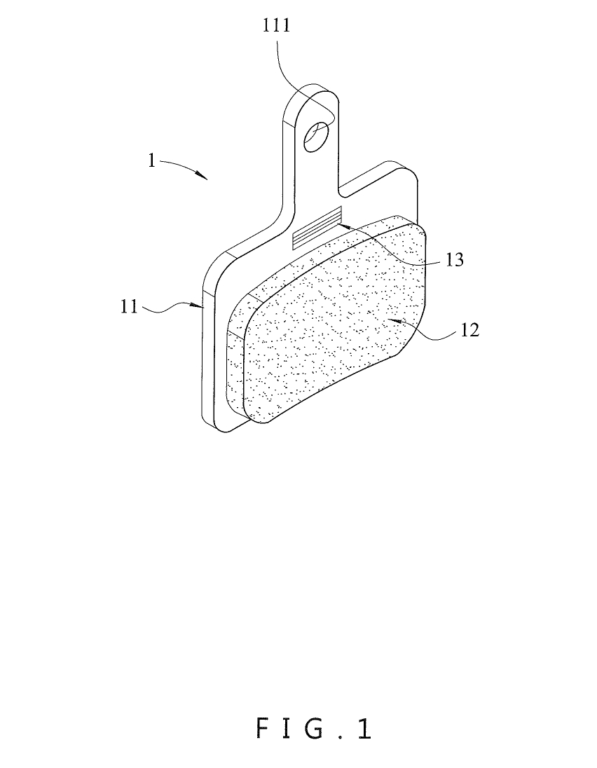

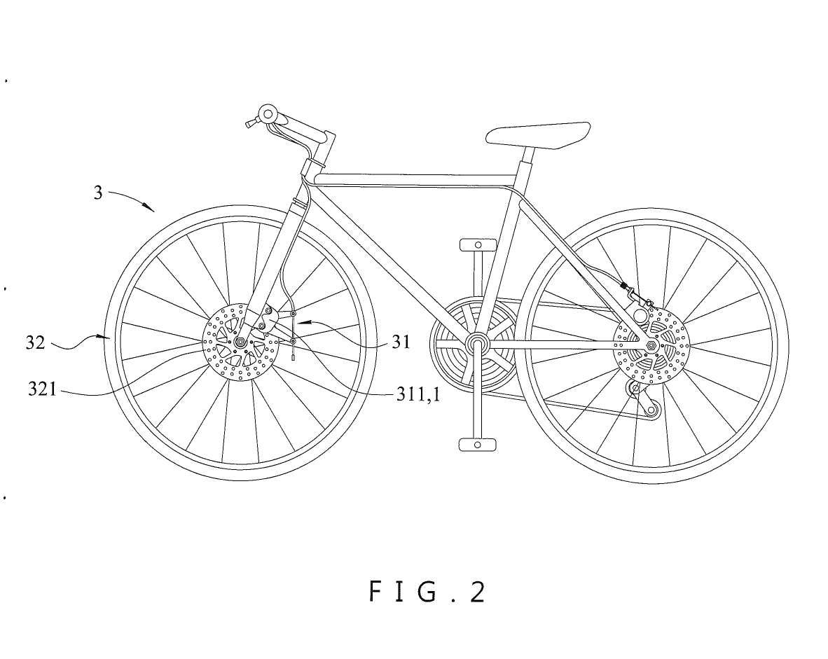

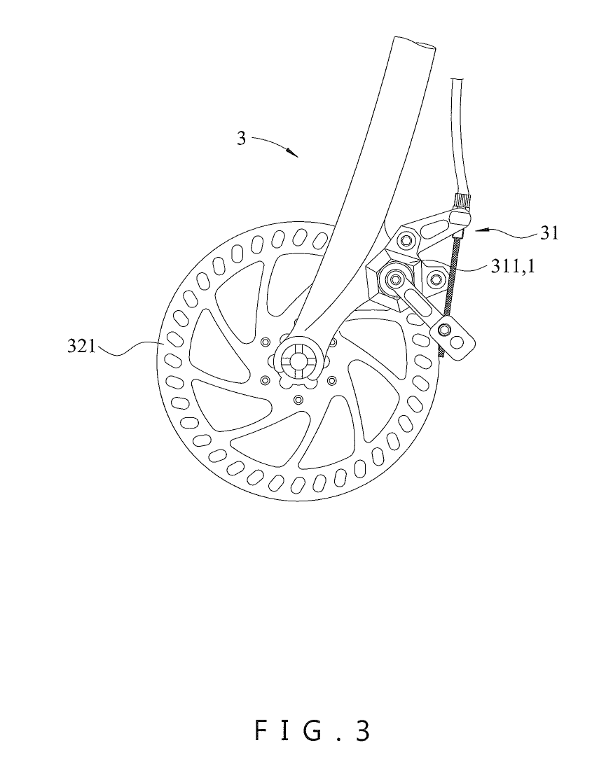

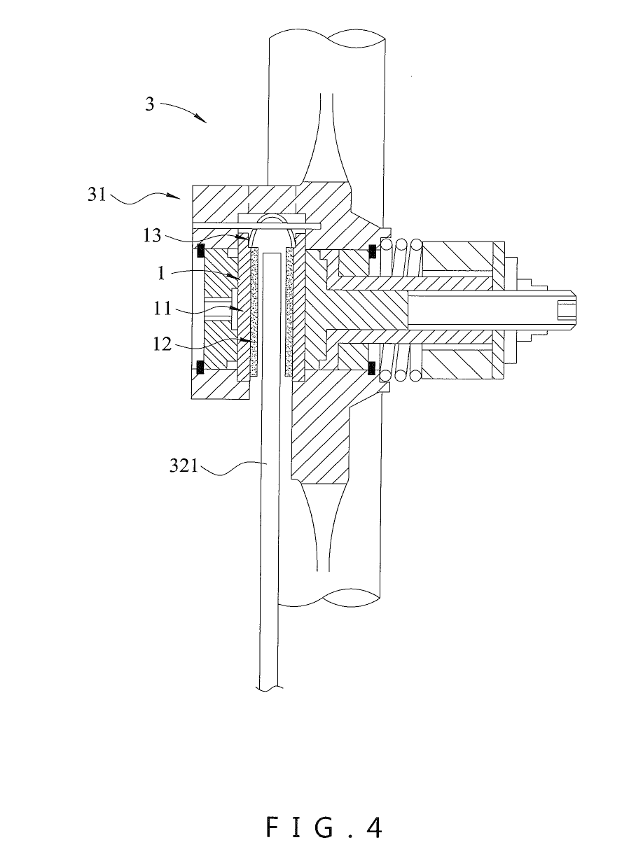

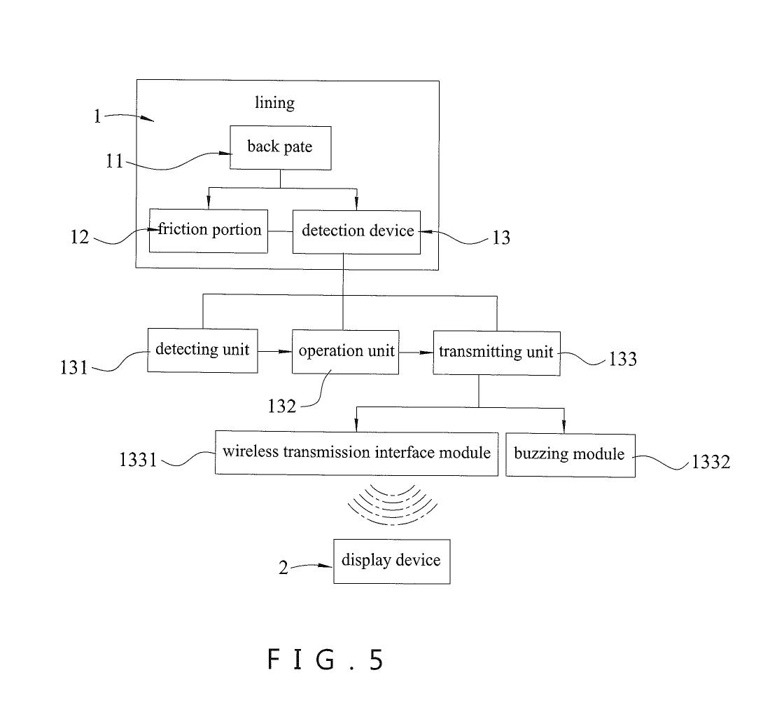

Referring to FIGS. 1-5, a bicycle lining wear indication system in accordance with the preferred embodiment of the present invention comprises a lining 1 and a display device 2.

The lining 1 includes a back pate 11, a friction portion 12 combined with a surface of the back pate 11, and a detection device 13 mounted on the back pate 11.

The back pate 11 has a positioning hole 111 positioned on a brake caliper mechanism 311 of a brake 31 of a bicycle 3 to attach the back pate 11 to the brake 31. Preferably, the back pate 11 is made of metallic material or composite material so that the back pate 11 has a heat radiating effect. The friction portion 12 has a lump shape and has a greater friction coefficient. When in use, the back pate 11 is driven by the brake caliper mechanism 311 of the brake 31 to drive the friction portion 12, so that the friction portion 12 is moved to contact a disk 321 of a wheel 32 of the bicycle 3 so as to provide a braking effect to the wheel 32.

The detection device 13 includes a detecting unit 131, an operation unit 132 and a transmitting unit 133.

The detecting unit 131 is used for sensing and detecting a wear state of the friction portion 12 of the lining 1 after the friction portion 12 contacts and rubs the disk 321 of the wheel 32 to produce a friction coefficient characteristic.

The operation unit 132 is coupled to the detecting unit 131 to proceed an operation on the friction coefficient characteristic produced by the detecting unit 131 and to convert the friction coefficient characteristic into a digital value.

The transmitting unit 133 is coupled to the operation unit 132 to transmit the digital value produced by the operation unit 132 to the display device 2 to remind a rider of a wear extent of the friction portion 12. The transmitting unit 133 includes a wireless transmission interface module 1331 connected to the display device 2 to transmit the digital value produced by the operation unit 132 to the display device 2. In the preferred embodiment of the present invention, the wireless transmission interface module 1331 transmits the digital value produced by the operation unit 132 to the display device 2 by a wireless bluetooth transmission, a wireless emitting frequency transmission, a infrared wireless transmission or a wireless radio microwave transmission. The transmitting unit 133 further includes a buzzing module 1332 to transmit an alarm sound to remind the rider of replacement of the friction portion 12 of the lining 1. The buzzing module 1332 and the wireless transmission interface module 1331 of the transmitting unit 133 are operated synchronously. Alternatively, the buzzing module 1332 and the wireless transmission interface module 1331 of the transmitting unit 133 are operated individually.

The display device 2 is externally connected to the transmitting unit 133 of the detection device 13. In the preferred embodiment of the present invention, the display device 2 is an electronic product of a cell phone, a personal digital assistant or a tablet computer.

Accordingly, the detection device 13 monitors and detects the wear extent of the friction portion 12 so that the rider can replace the lining 1 when the friction portion 12 is worn out, thereby assuring the rider's safety when riding the bicycle 3. In addition, the buzzing module 1332 of the detection device 13 transmits an alarm sound to remind the rider of replacement of the friction portion 12 of the lining 1.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A bicycle lining wear indication system comprising:
a lining; and
a display device;
wherein:
the lining includes:
a back pate;
a friction portion combined with a surface of the back pate; and
a detection device mounted on the back pate;
the back pate has a positioning hole positioned on a brake caliper mechanism of a brake of a bicycle to attach the back pate to the brake;
the back pate is driven by the brake caliper mechanism of the brake to drive the friction portion, so that the friction portion is moved to contact a disk of a wheel of the bicycle so as to provide a braking effect to the wheel;
the detection device includes:
a detecting unit;
an operation unit; and
a transmitting unit;
the detecting unit is used for sensing and detecting a wear state of the friction portion of the lining after the friction portion contacts and rubs the disk of the wheel to produce a friction coefficient characteristic;
the operation unit is coupled to the detecting unit to proceed an operation on the friction coefficient characteristic produced by the detecting unit and to convert the friction coefficient characteristic into a digital value;
the transmitting unit is coupled to the operation unit to transmit the digital value produced by the operation unit to the display device to remind a rider of a wear extent of the friction portion; and
the display device is externally connected to the transmitting unit of the detection device.

2. The bicycle lining wear indication system of claim 1, wherein the transmitting unit includes a wireless transmission interface module connected to the display device to transmit the digital value produced by the operation unit to the display device.

3. The bicycle lining wear indication system of claim 2, wherein the wireless transmission interface module transmits the digital value produced by the operation unit to the display device by a wireless bluetooth transmission, a wireless emitting frequency transmission, a infrared wireless transmission or a wireless radio microwave transmission.

4. The bicycle lining wear indication system of claim 3, wherein the display device is an electronic product of a cell phone, a personal digital assistant or a tablet computer.

5. The bicycle lining wear indication system of claim 2, wherein the transmitting unit further includes a buzzing module to transmit an alarm sound to remind the rider of replacement of the friction portion of the lining.

6. The bicycle lining wear indication system of claim 5, wherein the buzzing module and the wireless transmission interface module of the transmitting unit are operated synchronously.

7. The bicycle lining wear indication system of claim 5, wherein the buzzing module and the wireless transmission interface module of the transmitting unit are operated individually.
